(19) United States
(12) Patent Application Publication
(10) Pub. No.: US 2025/0384648 A1
(43) Pub. Date: Dec. 18, 2025

(54) IMAGE PROCESSING SYSTEM FOR MERGING RIDER OBJECT BOX AND TWO-WHEEL CARRIER OBJECT BOX AND IMAGE PROCESSING METHOD THEREOF

(71) Applicant: INDUSTRIAL TECHNOLOGY RESEARCH INSTITUTE, Hsinchu (TW)

(72) Inventors: Hsiao-Ting LAI, Hsinchu City (TW); Po-Hong WANG, Tainan City (TW); Ming-Jiun LIAW, Zhunan Township (TW)

(73) Assignee: INDUSTRIAL TECHNOLOGY RESEARCH INSTITUTE, Hsinchu (TW)

(21) Appl. No.: 18/798,421

(22) Filed: Aug. 8, 2024

(30) Foreign Application Priority Data
Jun. 17, 2024 (TW) 113122321

(51) Int. Cl. G06V 10/25; G06V 10/75; G06V 20/58

(52) U.S. Cl. CPC G06V 10/25; G06V 10/759; G06V 20/58

(57) ABSTRACT

An image processing system includes a first memory, a second memory, an area sorting unit and a merging unit. The first memory is configured to store a number of rider object boxes and a number of two-wheel carrier object boxes. The area sorting unit is configured to: read the rider object boxes in the first memory; obtain an rider object box area of each rider object box; and arrange the rider object boxes according to the order of the rider object box areas from large to small, and store them in the second memory. The merging unit is configured to: for each rider object box in the second memory, obtain the optimal-matching two-wheel carrier object box from the two-wheel carrier object boxes in the first memory; and create an emerged object box, wherein the emerged object box surrounds the rider object box and its optimal-matching two-wheel carrier object box.

This application claims the benefit of Taiwan application Serial No. 113122321, filed Jun. 17, 2024, the disclosure of which is incorporated by reference herein in its entirety.

### TECHNICAL FIELD

The disclosure relates in general to an image processing system and an image processing method thereof, and in particular, relates in an image processing system for merging a rider object box and a two-wheel carrier object box, and an image processing method thereof.

### BACKGROUND

For driving safety, image processing systems that may identify the types of objects on the road have appeared on the market. However, the more the types and/or the number of identified objects, the heavier the processing burden on the image processing system. Therefore, proposing an image processing technology capable of reducing the image processing burden is one of the goals of industry players in this technical field.

### SUMMARY

According to an embodiment, an image processing system for merging a rider object box and a two-wheel carrier object box is provided. The image processing system includes a first memory, a second memory, an area sorting unit, a data update unit and a merging unit. The first memory is configured to store a plurality of the rider object boxes and a plurality of the two-wheel carrier object boxes. The area sorting unit is configured to read the rider object boxes in the first memory; calculate a rider object box area of each of the rider object boxes; and arrange the rider object boxes in a descending order of the rider object box areas and store the arranged rider object boxes in the second memory. The data update unit is configured to delete all rider object boxes in the first memory. The merging unit is configured to for each of the rider object boxes in the second memory, obtain an optimal-matching two-wheel carrier object box from the two-wheel carrier object boxes in the first memory; and merge each of the rider object boxes and the corresponding optimal-matching two-wheel carrier object box to establish a merged object box, wherein an area of the merged object box covers an area of the corresponding rider object box and optimal-matching two-wheel carrier object box.

According to another embodiment, an image processing method for merging a rider object box and a two-wheel carrier object box is provided. The image processing method includes the following steps: storing a plurality of the rider object boxes and a plurality of the two-wheel carrier object boxes by a first memory; reading the rider object boxes in the first memory by an area sorting unit; calculating an rider object box area of each of the rider object boxes by the area sorting unit; arranging the rider object boxes in a descending order of the rider object box areas and storing the arranged rider object boxes in the second memory by the area sorting unit; deleting all rider object boxes in the first memory by a data update unit; for each of the rider object boxes in the second memory, obtaining an optimal-matching two-wheel carrier object box from the two-wheel carrier object boxes in the first memory by a merging unit; and merging each of the rider object boxes and the corresponding optimal-matching two-wheel carrier object box to create a merged object box by the merging unit, wherein an area of the merged object box covers an area of the corresponding rider object box and an area of its optimal-matching two-wheel carrier object box.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 illustrates a functional block diagram of an image processing system 100 according to an embodiment of the present disclosure;

FIG. 2A illustrates a schematic diagram of a frame of a plurality of rider object boxes BBr and a plurality of two-wheel carrier object boxes BBt according to a first embodiment of the present disclosure;

FIG. 2B illustrates a schematic diagram of the rider object boxes BBr and the two-wheel carrier object boxes BBt in FIG. 2A being merged into a plurality of merged object box BBm;

FIG. 3 illustrates a flow chart of an image processing method of the image processing system 100 in FIG. 1;

FIG. 4 illustrates a flow chart of determining the two-wheel carrier object box that optimally matches the rider object box according to an embodiment of the present disclosure;

FIG. 5 illustrates a geometric relationship diagram of the rider object box and the two-wheel carrier object box according to an embodiment of the present disclosure;

FIG. 6 illustrates a schematic diagram of a plurality of relative position types of the rider object box and the two-wheel carrier object box according to an embodiment of the present disclosure;

FIG. 7A illustrates a schematic diagram of a frame of the rider object box BBr and the two-wheel carrier object box BBt according to a second embodiment of the present disclosure;

FIG. 7B illustrates a schematic diagram of the rider object box BBr and the two-wheel carrier object box BBt in FIG. 7A being merged into the merged object box BBm; and

FIG. 8 illustrates a functional block diagram of an image processing system 200 according to another embodiment of the present disclosure.

### DETAILED DESCRIPTION

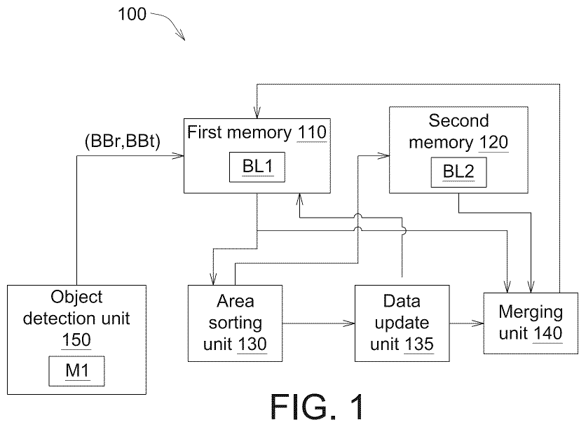

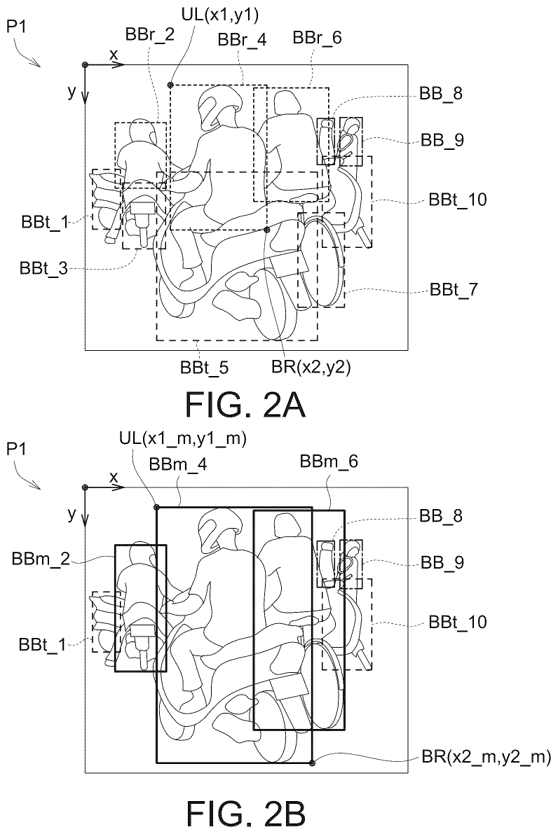

Referring to FIGS. 1 to 2B, FIG. 1 illustrates a functional block diagram of an image processing system 100 according to an embodiment of the present disclosure, FIG. 2A illustrates a schematic diagram of a frame of a plurality of rider object boxes BBr and a plurality of two-wheel carrier object boxes BBt according to a first embodiment of the present disclosure, and FIG. 2B illustrates a schematic diagram of the rider object boxes BBr and the two-wheel carrier object boxes BBt in FIG. 2A being merged into a plurality of merged object box BBm. The origin of the image coordinates in the figure is at an upper left corner of the image, wherein x-axis is, for example, a horizontal axis, and y-axis is, for example, a vertical axis. The x-axis and the y-axis are, for example, perpendicular to each other.

As shown in FIG. 1, the image processing system 100 includes a first memory 110, a second memory 120, an area sorting unit 130, a data update unit 135, a merging unit 140 and an object detection unit 150. The area sorting unit 130 is electrically connected to the first memory 110, the second memory 120 and the data update unit 135. The data update unit 135 is electrically connected to the first memory 110, the area sorting unit 130 and the merging unit 140. The merging unit 140 is electrically connected to the first memory 110, the second memory 120 and the data update unit 135. The object detection unit 150 is electrically connected to the first memory 110, the second memory 120 and the data update unit 135, and the object detection unit 150 is electrically connected to the first memory 110.

As shown in FIG. 1, the area sorting unit 130, the data update unit 135, the merging unit 140 and the object detection unit 150 may be firmware, software or hardware, where the hardware is, for example, a physical circuit, such as semiconductor wafers, semiconductor packages, etc., formed by using at least one semiconductor process. The first memory 110 and/or the second memory 120 are, for example, physical circuits formed by using at least one semiconductor process or storage variables in software and firmware programs. In an embodiment, at least two of the area sorting unit 130, the merging unit 140, the data update unit 135 and the object detection unit 150 may be integrated into a single component, such as a controller, a processor, etc.

As shown in FIGS. 1 to 2B, the first memory 110 is configured to store a plurality of the rider object boxes BBr and a plurality of the two-wheel carrier object boxes BBt. The area sorting unit 130 is configured to: read the rider object boxes BBr in the first memory 110; calculate a rider object box area Ar of each rider object box BBr; and arrange the rider object boxes BBr according to a descending order of the rider object box area Ar, and record (or store) the arranged rider object boxes BBr in the second memory 120. The merging unit 140 is configured to: for each of the rider object boxes BBr in the second memory 120, obtain the optimally-matching two-wheel carrier object box BBt from the two-wheel carrier object boxes BBt in the first memory 110; and establish a merged object box BBm, wherein the merged object box BBm surrounds the rider object box BBr and its optimal-matching two-wheel carrier object box BBt (for example, the rider object box BBr and its optimal-matching two-wheel carrier object box BBt does not protrude beyond the merged object box BBm). In an embodiment, subsequent object tracking may be performed on the merged object box BBm. Compared with tracking the rider object box BBr and the two-wheel carrier object box BBt separately (the processing burden of the two object boxes is heavier), the processing burden of the single merged object box BBm in the present embodiment of the present disclosure is reduced (for example, halved) and the time required for processing is also reduced. In addition, when measuring distance, the image processing system 100 may directly target the obtained merged object box BBm, without additionally searching for the two-wheel carrier object box corresponding to the rider object box. In addition, the merged object box BBm is, for example, single object box, and an area of the merged object box BBm may cover an area of the corresponding rider object box and an area of the optimal-matching two-wheel carrier object box.

Referring to a first object box table BL1 shown in Table 1 below, the first object box table BL1 lists a plurality of categories of the object boxes. For example, category 1 represents a rider category, category 2 represents a two-wheel carrier category, and category 0 represents other categories, such as pedestrian categories. The two-wheel carrier category includes, for example, various rideable vehicles such as motor vehicles and bicycles. The embodiments of the present disclosure do not limit the number and/or types of categories. In another embodiment, the number of categories may be less than 3, or greater than 3. The information of the first object box list BL1 may be stored in the first memory 110. In an embodiment, the object detection unit 150 may obtain a frame (for example, captured by a camera) based on an object detection model M1, and detect whether a preset object type that must be detected appears in the frame and detect a position of such object in the frame. Each object is represented by an object box, and its category is determined. Then, the categories and the object boxes of the object images may be listed in Table 1 and stored in the first memory. 110. The object detection unit 150 executes the object detection model M1 with an artificial intelligence. This object detection model M1 may be obtained, through conventional deep learning process, by using, for example, a machine learning technology (for example, deep learning technology or other known suitable technologies). This disclosed embodiment does not limit the technology of the object detection model M1. In addition, the aforementioned object detection unit 150 is, for example, a controller (not shown), a processor (not shown), or may be integrated into the merging unit 140.

TABLE 1
(the first object box table BL1)

| | | Upper left corner | | Lower right corner | |
|---|---|---|---|---|---|
| object | | point UL | | point BR | |
| box | category | x1 | y1 | x2 | y2 |
| BBt_1 | 2 | 15 | 206 | 67 | 322 |
| BBr_2 | 1 | 56 | 114 | 156 | 243 |
| BBt_3 | 2 | 75 | 234 | 155 | 361 |
| BBr_4 | 1 | 164 | 52 | 353 | 325 |
| BBt_5 | 2 | 138 | 213 | 451 | 540 |
| BBr_6 | 1 | 327 | 46 | 472 | 270 |
| BBt_7 | 2 | 414 | 292 | 502 | 475 |
| BB_8 | 0 | 451 | 105 | 484 | 197 |
| BB_9 | 0 | 494 | 105 | 535 | 198 |
| BBt_10 | 2 | 462 | 181 | 556 | 358 |

As shown in Table 1, each row presents information about an object box, which includes the category and the coordinate value of the object box, for example, the coordinate value of the upper left corner and the coordinate value of the lower right corner of the object box. The first row represents the two-wheel carrier object box BBt_1 in FIG. 2A, the second row represents the rider object box BBr_2 in FIG. 2A, the third row represents the two-wheel carrier object box BBt_3 in FIG. 2A, the fourth row represents the rider object box BBr_4 in FIG. 2A, the fifth row represents the two-wheel carrier object box BBt_5 in FIG. 2A, the sixth row represents the rider object box BBr_6 in FIG. 2A, the seventh row represents the two-wheel carrier object box BBt_7 in FIG. 2A, the eighth row represents the pedestrian object box BB_8 in FIG. 2A, the ninth row represents the pedestrian object box BB_9 in FIG. 2A, and the tenth row represents the rider object box BBr_10 in FIG. 2A.

Each object box has an upper left corner point UL and a lower right corner point BR, whose coordinates are represented by (x1, y1) and (x2, y2) respectively. As shown in Table 1, taking the fourth ranked rider object box BBr_4 (in the fourth row) as an example, referring to FIG. 2A, the coordinates of the upper left corner point UL of the rider object box BBr_4 are (164, 52), and the coordinates of the lower corner point BR are (353, 325). The unit of coordinate points is, for example, pixels.

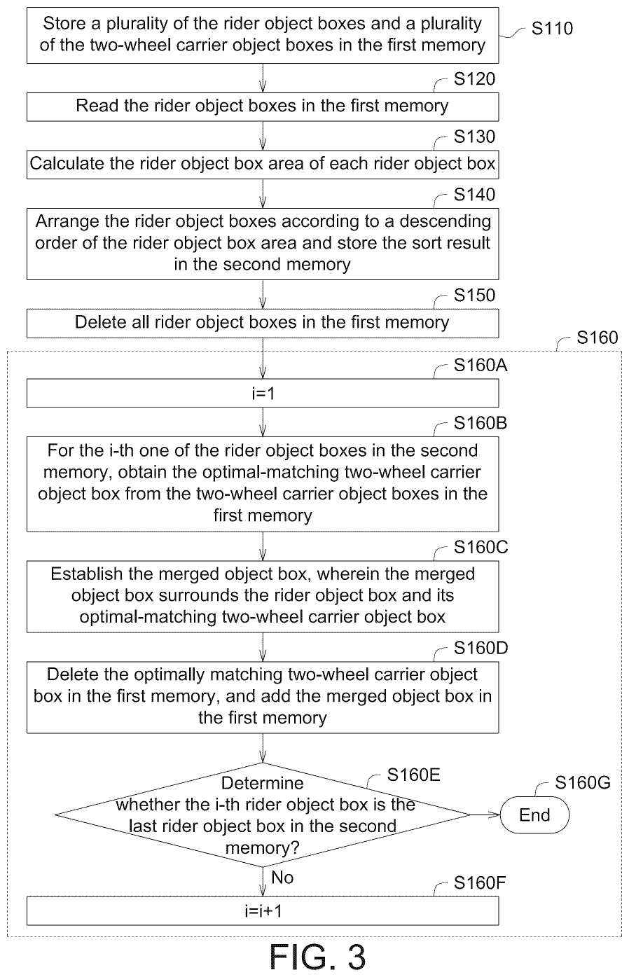

The following describes the process of the image processing method of the image processing system 100 in the embodiment of the present disclosure for the frame P1 in FIG. 2A with reference to FIG. 3. FIG. 3 illustrates a flow chart of an image processing method of the image processing system 100 in FIG. 1.

The following describes the first embodiment.

In step S110, as shown in FIG. 2A, the object detection unit 150 detects the category of the object image and the object box thereof in the frame P1, and then records the category of the object image and the object box thereof in the first memory 110, as shown in the aforementioned Table 1 (the first object box list BL1) which may include at least one object box and the category thereof. As shown in FIG. 2A, each object box has the upper left corner point UL and the lower right corner point BR. The coordinates of the upper left corner point UL are (x1, y1), and the coordinates of the lower right corner point BR are (x2, y2). In addition, the aforementioned picture P1 is captured, for example, by a camera (not illustrated) of the image processing system 100.

In step S120, the area sorting unit 130 reads the rider object boxes BBr in the first memory 110. Taking Table 1 as an example, the area sorting unit 130 reads the rider object box BBr_2 in the second row, the rider object box BBr_4 in the fourth row, and the rider object box BBr_6 in the sixth row in the first memory 110.

In step S130, the area sorting unit 130 calculates the rider object box area Ar of each rider object box BBr which is marked in Table 2 below. For example, the area sorting unit 130 calculates the rider object box area Ar of the rider object box BBr_2, the rider object box area Ar of the rider object box BBr_4, and the rider object box area Ar of the rider object box BBr_6 in the first memory 110. In an embodiment, the area sorting unit 130 may calculate the rider object box area Ar according to the following formula (1).

$$Ar = \vert x 2 - x 1 \vert \cdot \vert y 2 - y 1 \vert \qquad ( 1 )$$

In step S140, the area sorting unit 130 arranges the rider object boxes BBr according to a descending order of the rider object box areas Ar, and records (or stores) the arranged rider object boxes BBr in the second memory 120. For example, as shown in Table 2 below, the second object box table BL2 of the sorted rider object boxes BBr is listed.

TABLE 2
(the second object box table BL2)

| | object | | Upper left corner | | Lower right corner | |
|---|---|---|---|---|---|---|
| object | box area | | point UL | | point BR | |
| box | Ar | category | x1 | y1 | x2 | y2 |
| BBr_4 | 51597 | 1 | 164 | 52 | 353 | 325 |
| BBr_6 | 32480 | 1 | 327 | 46 | 472 | 270 |
| BBr_2 | 12900 | 1 | 56 | 114 | 156 | 243 |

In step S150, the data update unit 135 deletes all rider object boxes BBr in the first memory 110, as shown in Table 3 below.

TABLE 3
(the updated first object box table BL1′)

| | | Upper left corner | | Lower right corner | |
|---|---|---|---|---|---|
| object | | point UL | | point BR | |
| box | category | x1 | y1 | x2 | y2 |
| BBt_1 | 2 | 15 | 206 | 67 | 322 |
| BBt_3 | 2 | 75 | 234 | 155 | 361 |
| BBt_5 | 2 | 138 | 213 | 451 | 540 |
| BBt_7 | 2 | 414 | 292 | 502 | 475 |
| BB_8 | 0 | 451 | 105 | 484 | 197 |
| BB_9 | 0 | 494 | 105 | 535 | 198 |
| BBt_10 | 2 | 462 | 181 | 556 | 358 |

In step S160, for each of the rider object boxes BBr in the second memory 120, the merging unit 140 obtains the optimal-matching two-wheel carrier object box BBt from the two-wheel carrier object boxes BBt in the first memory 110. In an embodiment, for each of the rider object boxes BBr in the second memory 120, the merging unit 140 obtains the optimal-matching two-wheel carrier object box BBt according to a descending order (for example, a top-to-bottom order in Table 2) of the rider object box areas Ar from the two-wheel carrier object box BBt in the first memory 110 (for example, storing the first object box table BL1). After the rider object box BBr and its optimal-matching two-wheel carrier object box BBt is obtained, the merging unit 140 establishes the merged object box BBm surrounding the rider object box BBr and its optimal-matching two-wheel carrier object box BBt.

In step S160A, the merging unit 140 sets an initial value of i to 1.

In step S160B, taking the rider object box BBr_4 (the i-th rider object box in area sorting) as an example, for the rider object box BBr_4 (that is, the i-th one of the rider object boxes BBr) in the second memory 120, the merging unit 140 obtains the optimal-matching two-wheel carrier object box BBt from the two-wheel carrier object boxes BBt in the first memory 110. In the present embodiment, i is a positive integer ranging between 1 and N, and N is the total number of the rider object boxes in the second memory 120. In Table 2, N is equal to 3, for example. The merging unit 140 may compare each object box (for example, the two-wheel carrier object box BBt_1, BBt_3, BBt_5, BBt_7 and BBt_10) belonging to the two-wheel carrier category in Table 1 or Table 3, and determine the two-wheel carrier object box BBt (for example, the two-wheel carrier object box BBt_5) that optimally matches the rider object box BBr_4.

In step S160C, the merging unit 140 may establish the merged object box BBm_4 (the merged object box BBm_4 is illustrated in FIG. 2B), wherein the merged object box BBm_4 surrounds the to-be merged rider object box BBr_4 and its optimal-matching two-wheel carrier object box BBt_5 (the rider object box BBr_4 and the two-wheel carrier object box BBt_5 are illustrated in FIG. 2A).

In an embodiment, the merging unit 140 may obtain the upper left corner point UL (x1_m, y1_m) and the lower right corner point BR (x2_m, y2_m) of the merged object box BBm by calculating the upper left corner point UL (x1_r, y1_r) and the lower right corner point BR (x2_r, y2_r) of the rider object box and the upper left corner point UL (x1_t, y1_t) and the lower right corner point BR (x2_t, y2_t) of the optimal-matching two-wheel carrier object box BBt. For example, the merging unit 140 may calculate to obtain the upper left corner point UL (x1_m, y1_m) and the lower right corner point BR (x2_m, y2_m) of the merged object box BBm_4 by using the following formulas (a1) to (a4).

$$x1\_m = min ( x1\_r , x1\_t ) \qquad ( a1 )$$

$$x2\_m = max ( x2\_r , x2\_t ) \qquad ( a2 )$$

$$y1\_m = y1\_r \qquad ( a3 )$$

$$y2\_m = y2\_t \qquad ( a4 )$$

In addition, the merging unit 140 may obtain a width ΔW in the x-axis and the height ΔH in y-axis of the merged object box BBm_4 by using the following formulas (b1) to (b2).

$$Δ W = x2\_m - x1\_m \qquad ( b1 )$$

$$Δ H = y2\_m - y1\_m \qquad ( b2 )$$

In step S160D, after obtaining the first merged object box BBm_4, the merging unit 140 may update the first object box table BL1′_1. For example, as shown in the updated first object box table BL1′_1 of Table 4, the merging unit 140 deletes the optimally matching two-wheel carrier object box BBt_5 in the first memory 110 (or Table 3 above), and add the merged object box BBm_4 in the first memory 110 (or the above table 3), and attribute the merged object box BBm_4 to category 1. In another embodiment, the merging unit 140 may attribute the merged object box BBm_4 to a new category (for example, a category that is not included in the original object box list).

TABLE 4
(the updated first object box table BL1′_1)

| | | Upper left corner | | Lower right corner | |
|---|---|---|---|---|---|
| object | | point UL | | point BR | |
| box | category | x1 | y1 | x2 | y2 |
| BBt_1 | 2 | 15 | 206 | 67 | 322 |
| BBt_3 | 2 | 75 | 234 | 155 | 361 |
| BBt_7 | 2 | 414 | 292 | 502 | 475 |
| BB_8 | 0 | 451 | 105 | 484 | 197 |
| BB_9 | 0 | 494 | 105 | 535 | 198 |
| BBt_10 | 2 | 462 | 181 | 556 | 358 |
| BBm_4 | 1 | 138 | 52 | 451 | 540 |

In step S160E, the merging unit 140 determines whether the i-th rider object box BBr_4 is the last rider object box in the second memory 120 (or the above table 2). If so, the process proceeds to step S160G to end the matching and merging process. If not, the process proceeds to step S160F, the merging unit 140 accumulates the value of i (for example, i=i+1), and continues to obtain the optimal-matching two-wheel carrier object box with the next rider object box (for example, the i-th rider object box in area sorting).

Since there is still unmatched rider object box BBr_6 ranked second in area in the second memory 120 (as shown in Table 2 above), the process returns to step S160B.

In step S160B, taking the rider object box BBr_6 (the rider object box ranked second in area) as an example, the merging unit 140 compares each object box belonging to the two-wheel carrier category in Table 4 (for example, two-wheel carrier object boxes BBt_1, BBt_3, BBt_7 and BBt_10), and determine the two-wheel carrier object box BBt (for example, the two-wheel carrier object Box BBt_7) that optimally matches the rider object box BBr_6.

In step S160C, the merging unit 140 may establish the merged object box BBm_6 (the merged object box BBm_6 is illustrated in FIG. 2B), wherein the merged object box BBm_6 surrounds the to-be merged rider object box BBr_6 and its optimal-matching two-wheel carrier object box BBt_7 thereof (the rider object box BBr_6 and the two-wheel carrier object box BBt_7 are illustrated in FIG. 2A).

In step S160D, after obtaining the merged object box BBm_6, the merging unit 140 may update the first object box table BL1′_1 (as shown in Table 4 above). For example, as shown in the updated first object box table BL1′_2 shown in Table 5, the merging unit 140 deletes the optimal-matching two-wheel carrier object box BBt_7 in the first memory 110 (or Table 4 above), and add the merged object box BBm_6 in the first memory 110 (or the above table 4), and assign the merged object box BBm_6 to category 1. In another embodiment, the merging unit 140 may attribute the merged object box BBm_6 to a new category (for example, a category that is not included in the original object box table).

TABLE 5
(the updated first object box table BL1′_2)

| | | Upper left corner | | Lower right corner | |
|---|---|---|---|---|---|
| object | | point UL | | point BR | |
| box | category | x1 | y1 | x2 | y2 |
| BBt_1 | 2 | 15 | 206 | 67 | 322 |
| BBt_3 | 2 | 75 | 234 | 155 | 361 |
| BB_8 | 0 | 451 | 105 | 484 | 197 |
| BB_9 | 0 | 494 | 105 | 535 | 198 |
| BBt_10 | 2 | 462 | 181 | 556 | 358 |
| BBm_4 | 1 | 138 | 52 | 451 | 540 |
| BBm_6 | 1 | 327 | 46 | 502 | 475 |

In step S160E, the merging unit 140 determines whether the i-th rider object box BBr_6 is the last rider object box in the second memory 120 (or the above table 2). If so, the process proceeds to step S160G to end the matching process. If not, the process proceeds to step S160F, the merging unit 140 accumulates the value of i (for example, i=i+1), and continues to obtain the two-wheel carrier object that optimally matches the next (for example, the i-th rider object box in area sorting) box.

Since there is still unmatched rider object box BBr_2 ranked third in area in the second memory 120 (as shown in Table 2 above), the process returns to step S160B.

In step S160B, taking the rider object box BBr_2 (the rider object box ranked third in area) as an example, the merging unit 140 compares each object box belonging to the two-wheel carrier category in Table 5 (for example, the two-wheel carrier object boxes BBt_1, BBt_3 and BBt_10), and determine the two-wheel carrier object box BBt that optimally matches the rider object box BBr_2 (for example, the two-wheel carrier object box BBt_3).

In step S160C, the merging unit 140 may establish a merged object box BBm_2 (the merged object box BBm_2 is illustrated in FIG. 2B), wherein the merged object box BBm_2 surrounds the to-be merged rider object box BBr_2 and its optimal-matching two-wheel carrier object box BBt_3 thereof (the rider object box BBr_2 and the two-wheel carrier object box BBt_3 are illustrated in FIG. 2A).

In step S160D, after obtaining the merged object box BBm_2, the merging unit 140 may update the first object box table BL1′_2 (as shown in Table 5 above). For example, as shown in the updated first object box table BL1′_3 shown in Table 6, the merging unit 140 deletes the optimal-matching two-wheel carrier object box BBt_3 in the first memory 110 (or Table 5 above), and add the merged object box BBm_2 in the first memory 110 (or the above table 5), and assign the merged object box BBm_2 to category 1. In another embodiment, the merging unit 140 may attribute the merged object box BBm_2 to a new category (for example, a category that is not included in the original object box table).

TABLE 6
(the updated first object box table BL1′_3)

| | | Upper left corner | | Lower right corner | |
|---|---|---|---|---|---|
| object | | point UL | | point BR | |
| box | category | x1 | y1 | x2 | y2 |
| BBt_1 | 2 | 15 | 206 | 67 | 322 |
| BB_8 | 0 | 451 | 105 | 484 | 197 |
| BB_9 | 0 | 494 | 105 | 535 | 198 |
| BBt_10 | 2 | 462 | 181 | 556 | 358 |
| BBm_4 | 1 | 138 | 52 | 451 | 540 |
| BBm_6 | 1 | 327 | 46 | 502 | 475 |
| BBm_2 | 1 | 56 | 114 | 156 | 361 |

In step S160E, the merging unit 140 determines whether the i-th rider object box BBr_2 is the last rider object box in the second memory 120. If so, the process proceeds to step S160G to end the matching process. If not, the process proceeds to step S160F, the merging unit 140 accumulates the value of i (for example, i=i+1), and continues to obtain the two-wheel carrier object box BBt that optimally matches the next rider object box (for example, the i-th rider object box in area sorting).

Since all rider object boxes BBr_6 in the second memory 120 (as shown in Table 2 above) have been paired, the process proceeds to step S160G to end the pairing process. Subsequently, a trajectory tracking unit (not illustrated) of the image processing system 100 may perform a trajectory prediction or tracking based on the obtained merged object box. Furthermore, compared with separately tracking the rider object box BBr_6 and the two-wheel carrier object box BBt_5 (which causes a large processing load and taking a long time), the embodiment of the present disclosure performs tracking on single merged object box BBm_6 causes a smaller processing load (e.g., halved) and takes less time to process.

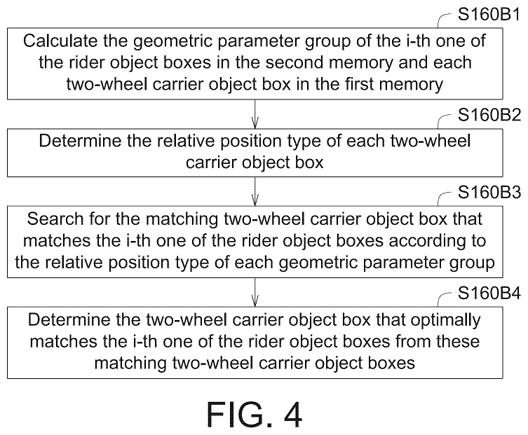

The following describes the process of step S160B in FIG. 3 according to an embodiment with reference to FIG. 4.

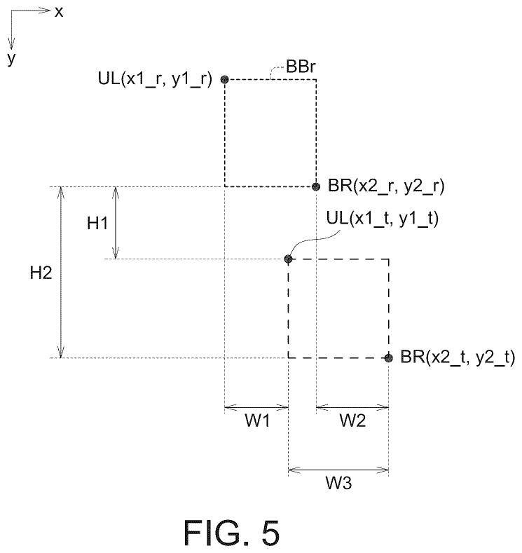

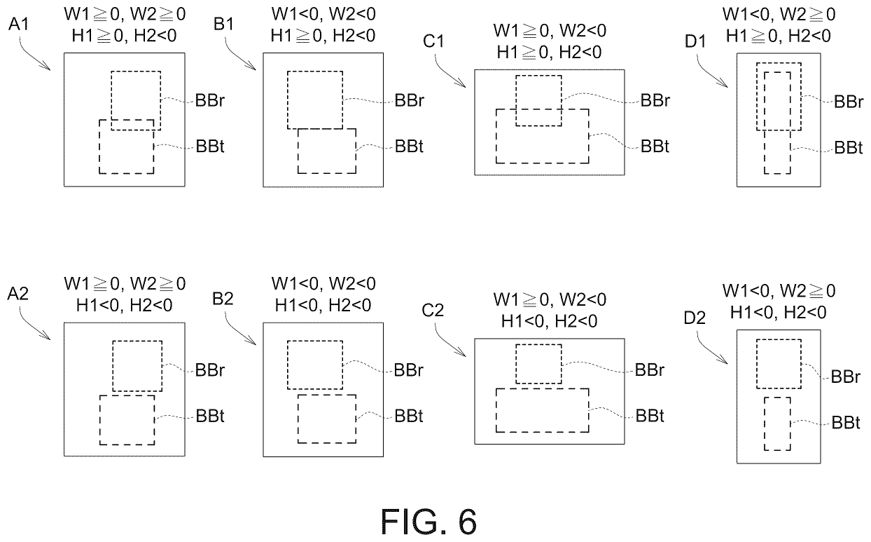

Referring to FIGS. 4 to 6, FIG. 4 illustrates a flow chart of determining the two-wheel carrier object box that optimally matches the rider object box according to an embodiment of the present disclosure, FIG. 5 illustrates a geometric relationship diagram of the rider object box and the two-wheel carrier object box according to an embodiment of the present disclosure, and FIG. 6 illustrates a schematic diagram of a plurality of relative position types of the rider object box and the two-wheel carrier object box according to an embodiment of the present disclosure.

In step S160B1, in a geometric parameter group calculation procedure, the merging unit 140 calculates a geometric parameter group of the i-th one of the rider object boxes BBr in the second memory and each two-wheel carrier object box BBt in the first memory. For example, for the i-th one of the rider object boxes BBr in the second memory, the merging unit 140 obtains the two-wheel carrier object boxes BBt from the first memory 110 (for example, Table 1 above), and calculate to obtain each geometric parameter group by using the following formulas (1a) to (1e), wherein each i-th of the two-wheel carrier object box in the first memory 110 and the i-th one of the rider object boxes BBr are corresponding to one geometric parameter group. As illustrated in FIG. 5, each geometric parameter group includes geometric parameters W1, W2, W3, H1 and H2.

In formulas (1a) to (1e), (x1_r, y1_r) is the coordinate of the upper left corner point UL of the rider object box BBr, (x2_r, y2_r) is the coordinate of the lower right corner point BR of the rider object box BBr, (x1_t, y1_t) is the coordinate of the upper left corner point UL of the two-wheel carrier object box BBt, and (x2_t, y2_t) is the coordinate of the lower right corner point BR of the two-wheel carrier object box BBt.

$$W 1 = x1\_r - x1\_t \qquad ( 1 a )$$

$$W 2 = x2\_r - x2\_t \qquad ( 1 b )$$

$$W 3 = x1\_r - x2\_t \qquad ( 1 c )$$

$$H 1 = y2\_r - y1\_t \qquad ( 1 d )$$

$$H 2 = y2\_r - y2\_t \qquad ( 1 e )$$

In step S160B2, in a relative position type determination procedure, the merging unit 140 determines a relative position type of each two-wheel carrier object box in the first memory 110 and the i-th one of the rider object boxes BBr according to the following table 7-1. As shown in the multiple relative position types illustrated in FIG. 6, the relative position types A1 to D1 belong to the relative position type in which the rider object box BBr and the two-wheel carrier object box BBt at least partially overlap, while the relative position types A2 to D2 belong to the relative position type of the rider object box BBr and the two-wheel carrier object box BBt do not overlap at all. Different relative position types correspond to different relative position type determination conditions of geometric parameters W1, W2, W3, H1 and H2. As shown in Table 7-1 below, if a geometric parameter group satisfies the relative position type determination condition of the relative position type A1, the merging unit 140 determines that the geometric parameter group belongs to relative position type A1. The determination method for the relative position types B1 to D1 and the relative position types A2 to D2 is the same as the relative position type A1. In addition, if H2>0, such object box of the two-wheel carrier is not matched.

TABLE 7-1

| | | Type A1 | Type B1 | Type C1 | Type D1 |
|---|---|---|---|---|---|
| Overlap | Relative | W1 ≥ 0; | W1 < 0; | W1 ≥ 0; | W1 < 0; |
| | position type | W2 ≥ 0; | W2 < 0; | W2 < 0; | W2 ≥ 0; |
| | determination | H1 ≥ 0; | H1 ≥ 0; | H1 ≥ 0; | H1 ≥ 0; |
| | condition | H2 < 0; | H2 < 0; | H2 < 0; | H2 < 0; |
| | x-axis offset | formula (211) | formula (212) | no determination required | |
| | matching | or formula | or formula | | |
| | condition | (215) | (216) | | |
| | y-axis offset | no determination required | | | |
| | matching | | | | |
| | condition | | | | |
| | area ratio | formula | formula | formula | formula |
| | matching | (214), | (214), | (214), | (214), |
| | condition | Th_area = | Th_area = | Th_area = | Th_area = |
| | | Th1 | Th1 | Th2 | Th3 |

| | | Type A2 | Type B2 | Type C2 | Type D2 |
|---|---|---|---|---|---|
| Non-overlap | Relative | W1 ≥ 0; | W1 < 0; | W1 ≥ 0; | W1 < 0; |
| | position type | W2 ≥ 0; | W2 < 0; | W2 < 0; | W2 ≥ 0; |
| | determination | H1 < 0; | H1 < 0; | H1 < 0; | H1 < 0; |
| | condition | H2 < 0; | H2 < 0; | H2 < 0; | H2 < 0; |
| | x-axis offset | formula (211) | formula (212) | no determination required | |
| | matching | or formula | or formula | | |
| | condition | (215) | (216) | | |
| | y-axis offset | formula (213) or formula (217) | | | |
| | matching | | | | |
| | condition | | | | |
| | area ratio | formula | formula | formula | formula |
| | matching | (214), | (214), | (214), | (214), |
| | condition | Th_area = | Th_area = | Th_area = | Th_area = |
| | | Th1 | Th1 | Th2 | Th3 |

The formulas (211), (212), (213) and (214) shown in Table 7-1 are listed below.

$$Abs ( \frac{W 1}{W 3} ) \leq Th1\_W \qquad ( 211 )$$

$$Abs ( \frac{W 2}{W 3} ) \leq Th2\_W \qquad ( 212 )$$

$$Abs ( \frac{H 1}{H 2} ) \leq Th1\_H \qquad ( 213 )$$

$$\frac{{A}_{r}}{{A}_{t}} \leq Th\_area \qquad ( 214 )$$

In another embodiment, formulas (211), (212) and (213) may be replaced by the following formulas (215), (216) and (217) respectively.

$$Abs ( \frac{W 1}{( W 1 + W 3 )} ) \leq Th3\_W \qquad ( 215 )$$

$$Abs ( \frac{W 2}{( W 2 + W 3 )} ) \leq Th4\_W \qquad ( 216 )$$

$$Abs ( \frac{H 1}{H 2 - H 1} ) \leq Th2\_H \qquad ( 217 )$$

In these formulas, the symbol “Abs( )” may take the absolute value of a value in “( )”. Each of Abs(W1/W3) of formula (211), Abs(W2/W3) of formula (212), Abs of formula (215) (W1/((W1+W3))) and Abs(W2/((W2+W3))) of formula (216) represents an offset degree (hereinafter referred to as “x-axis offset degree”) of the rider object box BBr and the two-wheel carrier object box BBt along an axis (for example, x axis). Each of Abs(H1/H2) of formula (213) and Abs(H1/(H2−H1)) of formula (217) represents an offset degree (hereinafter referred to as “y-axis offset degree”) of the rider object box BBr and the two-wheel carrier object box BBt along another axis (for example, y axis). Ar/At in formula (214) is a ratio (hereinafter referred to as “object box area ratio”) of the rider object area Ar of the rider object box BBr to the two-wheel carrier object box area At of the two-wheel carrier object box BBt. The parameters Th1_W, Th2_W, Th3_W and Th4_W are the threshold values of the x-axis offset matching condition, Th1_H and Th2_H are the threshold values of the y-axis offset matching condition, and Th_area is the threshold value of the area ratio matching condition. The embodiment of the present disclosure does not limit the specific values of the threshold values Th1_W, Th2_W, Th3_W, Th4_W, Th1_H, Th2_H and Th_area. In an embodiment, Th1_W may range between 0.3 and 1.0, Th2_W may range between 0.3 and 1.0, Th3_W may range between 0.2 and 0.8, Th4_W may range between 0.2 and 0.8, and Th1_H may range between 0.1 and 0.5, Th2_H may range between 0.1 and 0.5, and Th_area may range between 1.0 and 3.0. In addition, in Table 7-1, the threshold values Th1, Th2 and Th3 may be the same or different, and may be adjusted using a trial and error method to obtain the optimal effect.

In step S160B3, in a search matching object box procedure, the merging unit 140 searches for the matching two-wheel carrier object box (the “matching two-wheel carrier object box” is the “candidate” two-wheel carrier object box, and the subsequent optimal-matching two-wheel carrier object box is one of the candidate two-wheel carrier object boxes) that matches the i-th one according to the relative position type of each geometric parameter group. For example, for the relative position types of the i-th one of the rider object boxes BBr and these two-wheel carrier object boxes BBt, the merging unit 140 may use the two-wheel carrier object boxes BBt that meets the x-axis offset matching condition, the y-axis offset matching condition and the area ratio matching condition as the two-wheel carrier object boxes that match the i-th one of the rider object boxes BBr according to the x-axis offset matching condition, the y-axis offset matching condition and the area ratio matching condition in Table 7-1. The total number of the matching two-wheel carrier object boxes may be 0, 1, or plural.

In step S160B4, the merging unit 140 determines the two-wheel carrier object box that optimally matches the i-th one of the rider object boxes BBr from these matching two-wheel carrier object boxes. For example, the merging unit 140 determines the two-wheel carrier object that optimally matches the i-th one of the rider object boxes BBr from 0, 1, or a plurality of the matching two-wheel carrier object boxes BBt.

When the total number of the matching two-wheel carrier object boxes is 0, it means that no two-wheel carrier object box may match the i-th one of the rider object boxes BBr. When the total number of the matching two-wheel carrier object boxes is 1, it means that the matching two-wheel carrier object box is the optimal-matching two-wheel carrier object box.

When the total number of matching two-wheel carrier object boxes is plural, as shown in Table 7-2 below, when the relative position type of the i-th one of the rider object boxes BBr and the matching two-wheel carrier object box belongs to type A1, A2, B1 or B2, the two-wheel carrier object box BBt that optimally matches the i-th one of the rider object boxes BBr is determined by using the minimum center distance or the minimum x-axis offset degree. When the relative position type of the i-th one of the rider object boxes BBr and the matching two-wheel carrier object box belongs to type C1, C2, D1 or D2, the two-wheel carrier object box BBt that optimally matches the i-th one of the rider object boxes BBr is determined by using the minimum center distance.

TABLE 7-2

| | | | |
|---|---|---|---|
| A1/A2 | B1/B2 | C1/C2 | D1/D2 |

| Optimal-matching | (1). the smallest one of | the smallest one of “ center |
|---|---|---|
| determination | “ center distances between the | distances between the |
| condition | matching rider object box and | matching rider object box and |
| | two-wheel carrier object | two-wheel carrier object |
| | boxes”; or | boxes” |
| | (2). the smallest one of “ x-axis | |
| | offset degrees” | |

In an embodiment, the “center distance” is, for example, a distance between two centers (for example, a middle position or a geometric center) of the two object boxes, and the “x-axis offset degree” may be obtained by, for example, depends on the relative position type, using Abs(W1/W3) of formula (211), Abs(W2/W3) of formula (212), Abs(W1/((W1+W3))) of formula (215) or Abs(W2/((W2+W3))) of formula (216).

The following takes the rider object box BBr_4 ranked first in area (the i-th one of the rider object boxes BBr) as an example.

In step S160B1, in a geometric parameter calculation procedure, the merging unit 140 may the geometry parameter groups and types of each two-wheel carrier object box BBt in the first memory 110 and the rider object box BBr_4 by using the above formulas (1a) to (1e). As shown in Table 8-1 below, each geometric parameter group includes geometric parameters W1, W2, W3, H1 and H2. The first row is a geometric parameter group of the two-wheel carrier object box BBt_1 and the rider object box BBr_4. The second row is a geometric parameter group of the two-wheel carrier object box BBt_3 and the rider object box BBr_4. The third row is a geometric parameter group of the two-wheel carrier object box BBt_5 and the rider object box BBr_4. The fourth row is a geometric parameter group of the two-wheel carrier object box BBt_7 and the rider object box BBr_4. The fifth row is a geometric parameter group of the two-wheel carrier object box BBt_10 and the rider object box BBr_4. In Table 8-1, the parameter H2>0 of the two-wheel carrier object box BBt_1 does not belong to any type, so the two-wheel carrier object box BBt_1 may be excluded from the matching candidates.

TABLE 8-1
(with rider object box BBr_4)

| | | | | | | relative |
|---|---|---|---|---|---|---|
| object | | | | | | position |
| box | W1 | W2 | W3 | H1 | H2 | type |
| BBt_1 | 149 | 286 | 97 | 119 | 3 | N/A |
| BBt_3 | 89 | 198 | 9 | 91 | −36 | A1 |
| BBt_5 | 26 | −98 | −287 | 112 | −215 | C1 |
| BBt_7 | −250 | −149 | −338 | 33 | −150 | B1 |
| BBt_10 | −298 | −203 | −392 | 144 | −33 | B1 |

In step S160B2, in the relative position type determination procedure, the merging unit 140 determines the relative position type of each geometric parameter group (that is, each row of geometric parameter groups) in Table 8-1 according to Table 7-1. The determination results of the relative position type are listed in the “relative position type” field in Table 8-1.

In step S1601B3, in the search matching object box procedure, the merging unit 140 obtains the rider object box BBr that matches the rider object box BBr_4 from the first memory 110 according to the relative position type of each geometric parameter group (that is, each row of the geometric parameter groups), as shown in Table 8-2.

TABLE 8-2
(with the rider object box BBr_4)

| | x-axis offset | | object box | |
|---|---|---|---|---|
| | degree, formulas | | area ratio, | |
| | (211) or (212), | | formula | meets the |
| object | Th1_W = 0.6; | y-axis offset | (214), | matching |
| box | Th2_W = 0.6 | degree | Th_area = 2.5 | condition |
| BBt_3 | 9.89 | No | 5.08 | x |
| | | determination | | |
| | | required | | |
| BBt_5 | No | No | 0.50 | ∘ |
| | determination | determination | | |
| | required | required | | |
| BBt_7 | 0.74 | No | 3.20 | x |
| | | determination | | |
| | | required | | |
| BBt_10 | 0.76 | No | 3.10 | x |
| | | determination | | |
| | | required | | |

Taking the two-wheel carrier object box BBt_3 as an example, as shown in Table 8-1, the relative position type of the two-wheel carrier object box BBt_3 belongs to A1. According to Table 7-1, the x-axis offset degree (for example, 9.89) may be obtained by formula (211), the y-axis offset degree does not need to be determined, and the object box area ratio (for example, 5.08) may be obtained by formula (214). Take the two-wheel carrier object box BBt_5 as an example, as shown in Table 8-1, the relative position type of the two-wheel carrier object box BBt_5 belongs to C1. According to Table 7-1, the x-axis offset degree and the x-axis offset degree do no need to be determined, and the object box area ratio (for example, 0.5) may be obtained by formula (214). Taking the two-wheel carrier object box BBt_7 as an example, as shown in Table 8-1, the relative position type of the two-wheel carrier object box BBt_7 belongs to B1. According to Table 7-1, the x-axis offset degree (for example, 0.74) may be obtained, the y-axis offset degree does not need to be determined, and the object box area ratio (for example, 3.2) may be obtained by formula (214). Taking the two-wheel carrier object box BBt_10 as an example, as shown in Table 8-1, the relative position type of the two-wheel carrier object box BBt_10 belongs to B1. According to Table 7-1, the x-axis offset degree (for example, 0.76) may be obtained by formula (212), the y-axis offset degree does not need to be determined, and the object box area ratio (for example, 3.1) may be obtained by formula (214). It may be seen from Table 8-2 that the two-wheel carrier object box that matches the rider object box BBr_4 is only the two-wheel carrier object box BBt_5.

In step S160B4, the merging unit 140 obtains the two-wheel carrier object box BBt that optimally matches the rider object box BBr_4 from at least one matching two-wheel carrier object box BBt. For example, as shown in Table 8-2 above, among the two-wheel carrier object boxes BBt_3, BBt_5, BBt_7 and BBt_10, only the two-wheel carrier object box BBt_5 meets the matching conditions. Therefore, the merging unit 140 directly uses the two-wheel carrier object box BBt_5 as the optimal-matching two-wheel carrier object box. If there are two or more two-wheel carrier object boxes BBt that meet the matching conditions, the merging unit 140 determines the one with the shortest center distance among the two-wheel carrier object boxes BBt that meets the matching conditions according to Table 7-2.

The following is an example of the rider object box BBr_6 ranked second in area.

In step S160B1, in the geometric parameter group calculation procedure, the merging unit 140 may the geometry parameter groups and types of each two-wheel carrier object box BBt in the first memory 110 and the rider object box BBr_6 by using above formulas (1a) to (1e). As shown in Table 9-1 below, each geometric parameter group includes the geometric parameters W1, W2, W3, H1 and H2. The first row is a geometric parameter group of the two-wheel carrier object box BBt_1 and the rider object box BBr_4. The second row is a geometric parameter group of the two-wheel carrier object box BBt_3 and the rider object box BBr_4. The third row is a geometric parameter group of the two-wheel carrier object box BBt_7 and the rider object box BBr_4. The fourth row is a geometric parameter group of the two-wheel carrier object box BBt_10 and the rider object box BBr_4.

TABLE 9-1
(with rider object box BBr_6)

| | | | | | | relative |
|---|---|---|---|---|---|---|
| object | | | | | | position |
| box | W1 | W2 | W3 | H1 | H2 | type |
| BBt_1 | 312 | 405 | 260 | 64 | −52 | A1 |
| BBt_3 | 252 | 317 | 172 | 36 | −36 | A1 |
| BBt_7 | −87 | −30 | −175 | −22 | −150 | B2 |
| BBt_10 | −135 | −84 | −229 | 89 | −33 | B1 |

In step S160B2, in the relative position type determination procedure, the merging unit 140 determines the relative position type of each geometric parameter group (that is, each row of the geometric parameter groups) in Table 9-1 according to Table 7-1. The determination results of the relative position type are listed in Table 9-2.

(In step S1603, in the search matching object box procedure, the merging unit 140 obtains the rider object box BBr that matches the rider object box BBr_6, as shown in Table 9-2, from the first memory 110 according to the relative position type of each geometric parameter group (i.e., each row of the geometric parameter groups).

TABLE 9-2
(with rider object box BBr_6)

| | x-axis offset | | | |
|---|---|---|---|---|
| | degree, formulas | x-axis offset | object box | meets |
| | (211)or (212), | degree, | area ratio, | the |
| object | Th1_W = 0.6; | formula (213), | formula (214), | matching |
| box | Th2_W = 0.6 | Th1_H = 0.25 | Th_area = 2.5 | condition |
| BBt_1 | 1.20 | No determination | 5.38 | x |
| | | required | | |
| BBt_3 | 1.47 | No determination | 3.20 | |
| | | required | | x |
| BBt_7 | 0.50 | 0.15 | 2.02 | ∘ |
| BBt_10 | 0.59 | No determination | 1.95 | x |
| | | required | | |

Taking the two-wheel carrier object box BBt_1 as an example, as shown in Table 9-1, the relative position type of the two-wheel carrier object box BBt_1 belongs to A1. According to Table 7-1, the x-axis offset degree may be obtained by formula (211), the y-axis offset degree does not need to be determined, and the object box area ratio may be obtained by formula (214). Taking the two-wheel carrier object box BBt_3 as an example, the relative position type of the two-wheel carrier object box BBt_3 belongs to A3. According to Table 7-1, the x-axis offset degree may be obtained by formula (211), the y-axis offset degree does not need to be determined, and the object box area ratio may be obtained by formula (214). Taking the two-wheel carrier object box BBt_7 as an example, the relative position type of the two-wheel carrier object box BBt_7 belongs to B2. According to Table 7-1, the x-axis offset degree may be obtained by formula (212), the y-axis offset degree may be obtained by formula (213), and the object box area ratio may be obtained by formula (214). Taking the two-wheel carrier object box BBt_10 as an example, the relative position type of the two-wheel carrier object box BBt_10 belongs to B1. According to Table 7-1, the x-axis offset degree may be obtained by formula (212), the y-axis offset degree does not need to be determined, and the object box area ratio may be obtained by formula (214). It may be seen from Table 9-2 that the two-wheel carrier object box that matches the rider object box BBr_6 is only the two-wheel carrier object box BBt_7.

In step S160B4, the merging unit 140 obtains the two-wheel carrier object box BBt that optimally matches the rider object box BBr_6 from at least one matching two-wheel carrier object box BBt. For example, as shown in Table 9-2 above, only the two-wheel carrier object box BBt_7 satisfies the matching condition, so the merging unit 140 directly uses the two-wheel carrier object box BBt_7 as the optimal-matching two-wheel carrier object box. In addition, if there are two or more two-wheel carrier object boxes BBt that meet the matching conditions, the merging unit 140 determines the optimal-matching one of the matching two-wheel carrier object boxes BBt that meet the matching conditions according to Table 7-2.

The following is an example of the rider object box BBr_2 ranked third in area.

In step S160B1, in the geometric parameter group calculation procedure, the merging unit 140 may obtain the geometry parameter group and the type of each two-wheel carrier object box BBt in the first memory 110 and the rider object box BBr_2 by using the above formulas (1a) to (1e). As shown in Table 10-1 below, each geometric parameter group includes the geometric parameters W1, W2, W3, H1 and H2. The first row is the geometric parameter group of the two-wheel carrier object box BBt_1 and the rider object box BBr_2, while the second row is the geometric parameter group of the two-wheel carrier object box BBt_3 and the rider object box BBr_2, and so on.

TABLE 10-1
(with rider object box BBr_2)

| | | | | | | relative |
|---|---|---|---|---|---|---|
| object | | | | | | position |
| box | W1 | W2 | W3 | H1 | H2 | type |
| BBt_1 | 41 | 89 | −11 | 37 | −79 | A1 |
| BBt_3 | −19 | 1 | −99 | 9 | −118 | D1 |
| BBt_10 | −406 | −400 | −500 | 62 | −115 | B1 |

In step S160B2, in the relative position type determination procedure, the merging unit 140 determines the relative position type of each geometric parameter group (each row) in Table 10-1 according to Table 7-1. The determination results of the relative position type are listed in Table 10-1.

In step S160B3, in the search matching object box procedure, the merging unit 140 obtains at least one two-wheel carrier object box BBt that matches the rider object boxes BBr_2, as shown in Table 10-2, from the first memory 110 according to the relative position type of each geometric parameter group (each row).

TABLE 10-2
(with rider object box BBr_2)

| | x-axis offset | | | |
|---|---|---|---|---|
| | degree, formulas | | object box | |
| | (211) or (212), | | area ratio, | meets the |
| object | Th1_W = 0.6; | y-axis offset | formula (214), | matching |
| box | Th2 W = 0.6 | degree | Th_area = 2.5 | condition |
| BBt_1 | 3.73 | No | 2.14 | x |
| | | determination | | |
| | | required | | |
| BBt_3 | 0.19 | No | 1.27 | ∘ |
| | | determination | | |
| | | required | | |
| BBt_10 | 0.81 | No | 0.78 | x |
| | | determination | | |
| | | required | | |

Take the two-wheel carrier object box BBt_1 as an example. As shown in Table 10-1, the relative position type of the two-wheel carrier object box BBt_1 belongs to type A1. According to Table 7-1, the x-axis offset degree may be obtained by formula (211), the y-axis offset degree does not need to be determined, the object box area ratio may be obtained by formula (214). Take the two-wheel carrier object box BBt_3 as an example. As shown in Table 10-1, the relative position type of the two-wheel carrier object box BBt_1 belongs to type D1. According to Table 7-1, the x-axis offset degree and the y-axis offset degree do not need to be determined, and the object box area ratio may be obtained by formula (214). Taking the two-wheel carrier object box BBt_10 as an example, as shown in Table 10-1, the relative position type of the two-wheel carrier object box BBt_1 belongs to type B1. According to Table 7-1, the x-axis offset degree may be obtained by formula (212), the y-axis offset degree does not need to be determined, and the object box area ratio may be obtained by formula (214). It may be seen from Table 10-2 that the two-wheel carrier object box that matches the rider object box BBr_2 is only the two-wheel carrier object box BBt_3.

In step S160B4, the merging unit 140 obtains the two-wheel carrier object box BBt that optimally matches the rider object box BBr_2 from at least one matching two-wheel carrier object box BBt. For example, as shown in Table 10-2 above, only the two-wheel carrier object box BBt_3 satisfies the matching condition, and thus the merging unit 140 directly uses the two-wheel carrier object box BBt_3 as the optimal-matching two-wheel carrier object box. In addition, if there are two or more two-wheel carrier object boxes BBt that meet the matching conditions, the merging unit 140 determines the optimal-matching one of the matching two-wheel carrier object boxes BBt that meet the matching conditions according to Table 7-2.

The second embodiment will be described below.

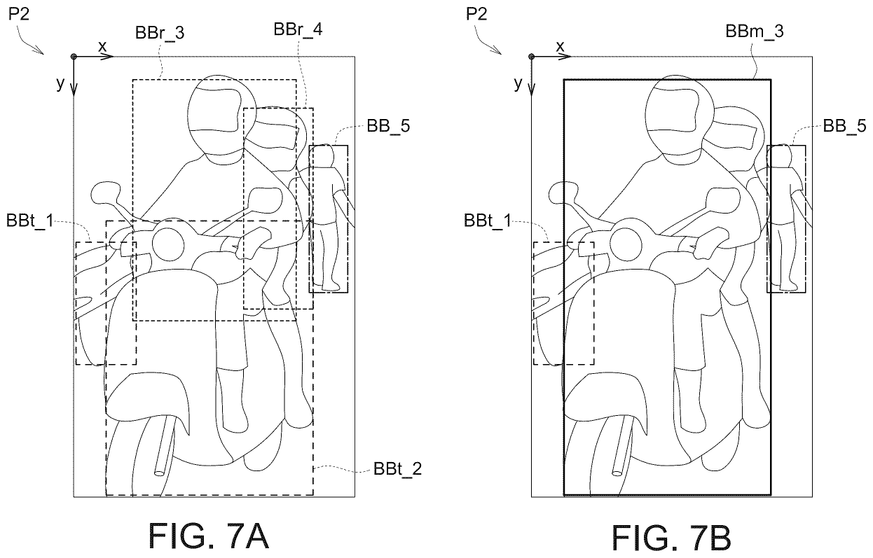

Referring to FIGS. 7A and 7B, FIG. 7A illustrates a schematic diagram of a frame of the rider object box BBr and the two-wheel carrier object box BBt according to a second embodiment of the present disclosure, and FIG. 7B illustrates a schematic diagram of the rider object box BBr and the two-wheel carrier object box BBt in FIG. 7A being merged into the merged object box BBm.

The following describes the processes of the image processing method of the image processing system 100 for the frame P2 in FIG. 7A with reference to FIGS. 3 and 4.

In step S110, after determining the category of the object image and its object box in the frame P2, the object detection unit 150 records them in the first memory 110, as shown in Table 11 (the first object box table BL1), which may contain at least one object box and its category.

TABLE 11
(the first object box table BL1)

| | | Upper left corner | | Lower right corner | |
|---|---|---|---|---|---|
| object | | point UL | | point BR | |
| box | category | x1 | y1 | x2 | y2 |
| BBt_1 | 2 | 5 | 261 | 85 | 431 |
| BBt_2 | 2 | 46 | 233 | 330 | 614 |
| BBr_3 | 1 | 81 | 34 | 311 | 371 |
| BBr_4 | 1 | 237 | 75 | 335 | 354 |
| BB_5 | 0 | 329 | 126 | 382 | 331 |

In step S120, the area sorting unit 130 reads the rider object boxes BBr in the first memory 110. Taking Table 11 as an example, the area sorting unit 130 may read the rider object box BBr_3 ranked third and the rider object box BBr_4 ranked fourth in the first memory 110.

In step S130, the area sorting unit 130 calculates the rider object box area Ar of each rider object box BBr which is listed in Table 12 below. For example, the area sorting unit 130 obtains the rider object box area Ar of the rider object box BBr_3 and the rider object box area Ar of the rider object box BBr_4 in the first memory 110. In an embodiment, the area sorting unit 130 may calculate and obtain the rider object box area Ar according to the above formula (1).

In step S140, the area sorting unit 130 arranges the rider object boxes BBr in descending order according to the rider object box area Ar, and records them in the second memory 120. For example, as shown in Table 12 below, it shows the second object box table BL2 listing the sorted rider object boxes BBr.

TABLE 12
(the second object box table BL2)

| | object | | Upper left corner | | Lower right corner | |
|---|---|---|---|---|---|---|
| object | box area | | point UL | | point BR | |
| box | Ar | category | x1 | y1 | x2 | y2 |
| BBr_3 | 77510 | 1 | 81 | 34 | 311 | 371 |
| BBr_4 | 27342 | 1 | 237 | 75 | 335 | 354 |

In step S150, the data update unit 135 deletes all rider object boxes BBr in the first memory 110, as shown in Table 13 below.

TABLE 13
(the updated first object box table BL1′)

| | | Upper left corner | | Lower right corner | |
|---|---|---|---|---|---|
| object | | point UL | | point BR | |
| box | category | x1 | y1 | x2 | y2 |
| BBt_1 | 2 | 5 | 261 | 85 | 431 |
| BBt_2 | 2 | 329 | 126 | 382 | 331 |
| BB_5 | 0 | 329 | 126 | 382 | 331 |

In step S160, for each of the rider object boxes BBr in the second memory 120, the merging unit 140 obtains the optimal-matching two-wheel carrier object box BBt, in a descending order (for example, from top to bottom in Table 12), from the two-wheel carrier object boxes BBt in the first memory 110 (for example, storing the first object box table BL1). After the rider object box BBr and its optimal-matching two-wheel carrier object box BBt, the merging unit 140 establishes the merged object box BBm surrounding the rider object box BBr and its optimal-matching two-wheel carrier object box BBt. Further examples are given below.

In step S160A, the merging unit 140 sets the initial value of i to 1.

In step S160B, taking the rider object box BBr_3 (the i-th rider object box in area sorting) as an example, for the rider object box BBr_3 (that is, the i-th one of the rider object boxes BBr) in the second memory 120, the merging unit 140 determines the optimal-matching two-wheel carrier object box BBt from these two-wheel carrier object boxes BBt in the first memory 110. For example, the merging unit 140 may compare each object box (for example, the two-wheel carrier object boxes BBt_1 and BBt_2) belonging to the two-wheel carrier category in Table 11 or Table 13, and obtain the two-wheel carrier object box BBt (for example, two-wheel carrier object box BBt_2) that optimally matches the rider object box BBr_3 from these object boxes.

The following describes the process of step S160B with reference to the steps S160B1 to S160B7 in FIG. 4.

In step S160B1, in the geometric parameter group calculation procedure, the merging unit 140 may calculate and obtain the geometric parameter groups of each two-wheel carrier object box BBt in the first memory 110 and the rider object box BBr_3 by using the above formulas (1a) to (1e). As shown in Table 14-1 below, each geometric parameter group includes the geometric parameters W1, W2, W3, H1 and H2. The first row is the geometric parameter group of the two-wheel carrier object box BBt_1 and the rider object box BBr_3, while the second row is the geometric parameter group of the two-wheel carrier object box BBt_2 and the rider object box BBr_3.

TABLE 14-1
(with the rider object box BBr_3)

| | | | | | | relative |
|---|---|---|---|---|---|---|
| object | | | | | | position |
| box | W1 | W2 | W3 | H1 | H2 | type |
| BBt_1 | 76 | 226 | −4 | 110 | −60 | A1 |
| BBt_2 | 35 | −19 | −249 | 138 | −243 | C1 |

In step S160B2, in the relative position type determination procedure, the merging unit 140 determines the relative position type of each geometric parameter group (i.e., each row of the geometric parameter groups) in Table 14-1 according to the above Table 7-1. The determination results of the relative position type are listed in the “the relative position type” field of Table 14-1.

In step S160B3, in the search matching object box procedure, the merging unit 140 obtains at least one or two-wheel carrier object box BBt that matches the rider object box BBr_3 from the first memory 110, as shown in Table 1-2, according to the relative position type of each geometric parameter group (i.e., each row of the geometric parameter groups).

TABLE 14-2
(with the rider object box BBr_3)

| | x-axis | | object box | |
|---|---|---|---|---|
| | offset degree, | | area ratio, | meets the |
| object | formula (211), | y-axis offset | formula (214), | matching |
| box | Th1_W = 0.6 | degree | Th_area = 2.5 | condition |
| BBt_1 | 19.00 | No | 5.70 | x |
| | | determination | | |
| | | required | | |
| BBt_2 | 0.14 | No | 0.72 | ∘ |
| | | determination | | |
| | | required | | |

Taking the two-wheel carrier object box BBt_1 as an example, as shown in Table 14-1, the relative position type of the two-wheel carrier object box BBt_1 belongs to type A1. According to Table 7-1, the x-axis offset degree may be obtained by formula (211), the y-axis offset degree does not need to be determined, and the object box area ratio may be obtained by formula (214). Take the two-wheel carrier object box BBt_2 as an example. As shown in Table 14-1, the relative position type of the two-wheel carrier object box BBt_2 belongs to type C1. According to Table 7-1, the x-axis offset degree and the y-axis offset degree do not to be determined, and the object box area ratio may be obtained by formula (214). It may be seen from Table 14-2 that the two-wheel carrier object box that matches the rider object box BBr_3 is only the two-wheel carrier object box BBt_2.

In step S160B4, the merging unit 140 obtains the two-wheel carrier object box BBt that optimally matches the rider object box BBr_3 from at least one matching two-wheel carrier object box BBt. For example, as shown in Table 14-2 above, only the two-wheel carrier object box BBt_2 satisfies the matching condition, and thus the merging unit 140 directly uses the two-wheel carrier object box BBt_2 as the optimal-matching two-wheel carrier object box. In addition, if there are two or more two-wheel carrier object boxes BBt that meet the matching conditions, the merging unit 140 determines the optimal-matching one of the matching two-wheel carrier object boxes BBt that meet the matching conditions according to Table 7-2.

In step S160C, the merging unit 140 may establish the merged object box BBm_3 (the merged object box BBm_3 is illustrated in FIG. 7B), wherein the merged object box BBm_3 surrounds the processing rider object box BBr_3 and it the optimal-matching two-wheel carrier object box BBt_2 (the rider object box BBr_3 and the two-wheel carrier object box BBt_2 are illustrated in FIG. 7A). In an embodiment, the merging unit 140 may calculate and obtain the coordinates of the upper left corner point UL and the coordinates of the lower right corner point BR of the merged object box BBm_3 by using the above formulas (a1) to (a4), and may calculate and obtain the width of the merged object box BBm_3 in x-axis and the height of the merged object box BBm_3 in y-axis by using the above formulas (b1) to (b2).

In step S160D, after obtaining the merged object box BBm_3, the merging unit 140 may update the first object box table BL1′ (as shown in Table 13 above). For example, as shown in the updated first object box table BL1′_1 shown in Table 14-3 below, the merging unit 140 deletes the optimal-matching two-wheel carrier object box BBt_2 in the first memory 110, adds the merged object box BBm_3 to the first memory 110, and attributes the merged object box BBm_3 to the category 1. In another embodiment, the merging unit 140 may attribute the merged object box BBm_3 to a new category (for example, a category that is not included in the original object box table).

TABLE 14-3
(the updated first object box table BL1′ 1)

| | | Upper left corner | | Lower right corner | |
|---|---|---|---|---|---|
| object | | point UL | | point BR | |
| box | category | x1 | y1 | x2 | y2 |
| BBt_1 | 2 | 5 | 261 | 85 | 431 |
| BB_5 | 0 | 329 | 126 | 382 | 331 |
| BBm_3 | 1 | 46 | 34 | 330 | 614 |

In step S160E, the merging unit 140 determines whether the i-th rider object box BBr_4 is the last rider object box in the second memory 120. If so, the process proceeds to step S160G to end the matching process. If not, the process proceeds to step S160F, the merging unit 140 accumulates the value of i (for example, i=i+1), and continues to obtain the two-wheel carrier object that optimally matches the next (for example, the i-th rider object box in area sorting) box, as explained below.

Since there is still unmatched rider object box BBr_4 ranked second in area in the second memory 120 (as shown in Table 12 above), the process returns to step S160B.

In step S160B, taking the rider object box BBr_4 (the rider object box ranked second in area) as an example, the merging unit 140 compares each object box belonging to the two-wheel carrier category in Table 14-3 (for example, the two-wheel carrier object box BBt_1), and the two-wheel carrier object box BBt that optimally matches the rider object box BBr_4 was not found. The following uses steps S160B1 to 160B4 in FIG. 4 to further illustrate step S160B.

In step S160B1, in the geometric parameter group calculation procedure, the merging unit 140 may obtain the geometry parameter groups of each two-wheel carrier object box BBt in the first memory 110 and the rider object box BBr_4 by above formulas (1a) to (1e). As shown in Table 15-1 below, each geometric parameter group includes the geometric parameters W1, W2, W3, H1 and H2. The first row is the geometric parameter group of the two-wheel carrier object box BBt_1 and the rider object box BBr_4.

TABLE 15-1
(with the rider object box BBr_4)

| | | | | | | relative |
|---|---|---|---|---|---|---|
| object | | | | | | position |
| box | W1 | W2 | W3 | H1 | H2 | type |
| BBt_1 | 232 | 250 | 152 | 93 | −77 | A1 |

In step S160B2, in the relative position type determination procedure, the merging unit 140 determines the relative position type of each geometric parameter group (i.e., each row of the geometric parameter groups) in Table 15-1 according to the above Table 7-1. The determination results of the relative position type are listed in Table 15-1.

In step S160B3, in the search matching object box procedure, the merging unit 140 obtains at least one or two-wheel carrier object boxes BBt that matches the rider object box BBr_4, as shown in Table 15-2, from the first memory 110 according to the relative position type of each geometric parameter group (i.e., each row of the geometric parameter groups).

TABLE 15-2
(with the rider object box BBr_4)

| | x-axis offset | y-axis offset | object box | |
|---|---|---|---|---|
| | degree, | degree, | area ratio, | meets the |
| object | formula (211), | formula (215), | formula (217), | matching |
| box | Th1_W = 0.6 | Th2 W = 0.25 | Th_area = 2.5 | condition |
| BBt_1 | 1.53 | no determination | 5.70 | x |
| | | required | | |

Take the two-wheel carrier object box BBt_1 as an example, as shown in Table 15-1, the relative position type of the two-wheel carrier object box BBt_1 belongs to type A1. According to Table 7-1, the x-axis offset degree may be obtained by formula (211), the y-axis offset degree does not need to be determined, and the object box area ratio may be obtained by formula (214). It may be seen from Table 15-2 that the two-wheel carrier object box BBt_1 cannot meet the matching condition with the rider object box BBr_4, and thus the number of the two-wheel carrier object boxes matching the rider object box BBr_4 is zero.

In step S160B4, the merging unit 140 determines the two-wheel carrier object box BBt that optimally matches the rider object box BBr_4 from at least one matching two-wheel carrier object box BBt. As shown in Table 15-2 above, since there is no two-wheel carrier object box that matches the rider object box BBr_4, there is no need to perform the object box merging procedure, and there is no need to update the first object box table.

The following describes the third embodiment.

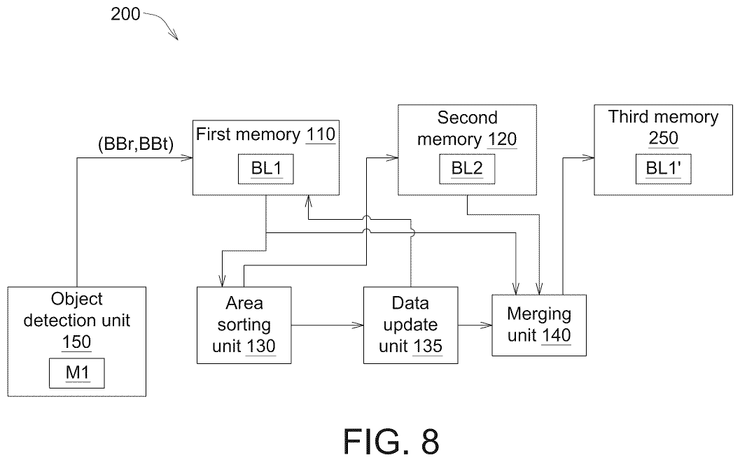

Referring to FIG. 8, FIG. 8 illustrates a functional block diagram of an image processing system 200 according to another embodiment of the present disclosure. The image processing system 200 includes the first memory 110, the second memory 120, the area sorting unit 130, the merging unit 140, the object detection unit 150 and a third memory 250. The first memory 110, the second memory 120 and/or the third memory 250 are, for example, physical circuits that may be formed by using at least one semiconductor process.

The image processing system 200 in the embodiment of the present disclosure includes technical features similar or the same as that of the aforementioned image processing system 100, and at least one difference is that the updated first object box table (for example, BL1′, BL1′_1, BL1′_2 and/or BL1′_3) may be stored in the third memory 250 in the image processing method of the aforementioned first embodiment or second embodiment. After all the rider object boxes are matched, the result may be also stored in the third memory. In one embodiment, subsequent object tracking may be performed on the object box stored in the third memory 250.

The following describes the fourth embodiment.

Although the foregoing embodiment uses the relative position type determination conditions, the x-axis offset matching condition and the y-axis offset matching condition and the area ratio matching condition in Table 7-1, this is not intended to limit the embodiments of the present disclosure. In the aforementioned image processing method of the first embodiment, Tables 7-1 and 7-2 used may be replaced by the following Tables 16-1 and 16-2 respectively. Alternatively, in the aforementioned image processing method of the second embodiment, Tables 7-1 and 7-2 used may be replaced by the following Tables 17-1 and 17-2 respectively. “sign( )” in Tables 16-1 and 17-1 takes the symbol “+” or symbol “−” of the value in “( )”.

TABLE 16-1

| | | Type E1 | TypeF1 | Type G1 |
|---|---|---|---|---|
| Overlap | Relative | W1 ≥ 0; | W1 < 0; | sign(W1) |
| | position type | W2 ≥ 0; | W2 < 0; | * sign(W2) < 0; |
| | determination | H1 ≥ 0; | H1 ≥ 0; | H1 ≥ 0; |
| | condition | H2 < 0; | H2 < 0; | H2 < 0; |
| | x-axis offset | formula (211) or | formula (212) or | no determination |
| | matching | formula (215) | formula (216) | required |
| | condition | | | |
| | y-axis offset | no determination required | | |
| | matching | | | |
| | condition | | | |
| | area ratio | formula (214), | formula (214), | formula (214), |
| | matching | Th_area = Th1 | Th_area = Th1 | Th_area = Th2 |
| | condition | | | |

| | | Type E2 | Type F2 | Type G2 |
|---|---|---|---|---|
| Non-overlap | Relative | W1 ≥ 0; | W1 < 0; | sign(W1) |
| | position type | W2 ≥ 0; | W2 < 0; | * sign(W2) < 0; |
| | determination | H1 < 0; | H1 < 0; | H1 < 0; |
| | condition | H2 < 0; | H2 < 0; | H2 < 0; |
| | x-axis offset | formula (211) or | formula (212) or | no determination |
| | matching | formula (215) | formula (216) | required |
| | condition | | | |
| | y-axis offset | formula (213) or formula (217) | | |
| | matching | | | |
| | condition | | | |
| | area ratio | formula (214), | formula (214), | formula (214), |
| | matching | Th_area = Th1 | Th_area = Th1 | Th_area = Th2 |
| | condition | | | |

TABLE 16-2

| | | |
|---|---|---|
| E1/E2 | F1/F2 | G1/G2 |

| | | |
|---|---|---|
| Optimal-matching | (1). the smallest one of “ center | the smallest one of “ center |
| determination | distances between the matching | distances between the |
| condition | rider object box and two-wheel | matching rider object box |
| | carrier object boxes”; or | and two-wheel carrier |
| | (2). the smallest one of “ x-axis | object boxes” |
| | offset degrees” | |

| | Table 17-1 | Type J1 | Type K1 |
|---|---|---|---|
| Overlap | Relative | sign(W1) * sign(W2) ≥ 0; | sign(W1) * sign(W2) < 0; |
| | position type | H1 ≥ 0; | H1 ≥ 0; |
| | determination | H2 < 0; | H2 < 0; |
| | condition | | |
| | x-axis offset | formula (211) or formula | no determination required |
| | matching condition | (215) | |
| | y-axis offset | no determination required | |
| | matching | | |
| | condition | | |
| | area ratio | formula (217), | formula (217), |
| | matching | Th_area = Th1 | Th_area = Th2 |
| | condition | | |

| | | Type J2 | Type K2 |
|---|---|---|---|
| Non-overlap | Relative | W_tmp ≥ 0; | W_tmp < 0; |
| | position type | H1 < 0; | H1 < 0; |
| | determination | H2 < 0; | H2 < 0; |
| | condition | | |
| | x-axis offset | formula (211) or formula | no determination |
| | matching | (215) | required |
| | condition | | |

| | |
|---|---|
| y-axis offset | formula (213) or formula (217) |

| | | |
|---|---|---|
| matching | | |
| condition | | |
| area ratio | formula (214), | formula (214), |
| matching | Th_area = Th1 | Th_area = Th2 |
| condition | | |

TABLE 17-2

| | J1/J2 | K1/K2 |
|---|---|---|
| Optimal-matching | (1). the smallest one of “ center | the smallest one of “ center |
| determination | distances between the matching | distances between the |
| condition | rider object box and two-wheel | matching rider object box |
| | carrier object boxes”; or | and two-wheel carrier |
| | (2). the smallest one of “ x-axis | object boxes” |
| | offset degrees” | |

In summary, embodiments of the present disclosure propose an image processing system and an image processing method for merging two object boxes, which may merge the rider object box and the two-wheel carrier object box into one merged object box. Compared with tracking the rider object box and the two-wheel carrier object box separately (the processing burden of the two object boxes is heavier), the processing burden of the single merged object box in the present embodiment of the present disclosure may be reduced (for example, halved) and the time required for processing is also reduced. In addition, when measuring distance, the image processing system may directly target the obtained merged object box, without additionally searching for the two-wheel carrier object box corresponding to the rider object box.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. An image processing system for merging a rider object box and a two-wheel carrier object box, comprising:
a first memory configured to store a plurality of the rider object boxes and a plurality of the two-wheel carrier object boxes;
a second memory;
an area sorting unit configured to:
read the rider object boxes in the first memory;
calculate a rider object box area of each of the rider object boxes; and
arrange the rider object boxes in a descending order of the rider object box areas and store the arranged rider object boxes in the second memory;
an data update unit configured to:
delete all rider object boxes in the first memory; and
a merging unit configured to:
for each of the rider object boxes in the second memory, obtain an optimal-matching two-wheel carrier object box from the two-wheel carrier object boxes in the first memory; and
merge each of the rider object boxes and the corresponding optimal-matching two-wheel carrier object box to establish a merged object box, wherein an area of the merged object box covers an area of the corresponding rider object box and an area of its optimal-matching two-wheel carrier object box.

2. The image processing system as claimed in claim 1, wherein the merging unit is further used to:
calculate a geometric parameter group of each of the two-wheel carrier object boxes in the first memory and an i-th one of the rider object boxes in the second memory, wherein i is a positive integer ranging between 1 and N, N is total number of all rider object boxes in the second memory, and a value of N is a positive integer equal to or greater than 1;
determine a relative position type of each of the geometric parameter groups;
determine whether there is the two-wheel carrier object box that matches the i-th one of the rider object boxes from the first memory according to the relative position type of each geometric parameter group;
when there is no the two-wheel carrier object box that matches the i-th one of the rider object boxes, not add the merging object box;
when the number of the two-wheel carrier object boxes that matches the i-th one of the rider object boxes is 1, merge the i-th one of the rider object boxes and the two-wheel carrier object box that matches the i-th one of the rider object boxes into the merged object box, add the merged object box to the first memory, and delete the two-wheel carrier object box that matches the i-th one of the rider object boxes into the merged object box in the first memory; and
when the number of the two-wheel carrier object boxes that matches the i-th one of the rider object boxes is plural, from the matching two-wheel carrier object boxes, compare a center distance of each two-wheel carrier object box that matches the i-th one of the rider object boxes and the i-th one of the rider object boxes, use the two-wheel carrier object box that matches the i-th one of the rider object boxes corresponding to a smallest one of the center distances as the optimal-matching two-wheel carrier object box, merge the i-th one of the rider object boxes and the optimal-matching two-wheel carrier object box into the merged object box, and delete the optimal-matching two-wheel carrier object box in the first memory.

3. The image processing system as claimed in claim 1, wherein the merging unit is further configured to:
when the number of the two-wheel carrier object boxes that matches the i-th one of the rider object boxes is plural, from the two-wheel carrier object boxes that matches the i-th one of the rider object boxes, compare an offset degree of each two-wheel carrier object box that matches the i-th one of the rider object boxes and the i-th one of the rider object boxes along an axis;
use the two-wheel carrier object boxes that matches the i-th one of the rider object boxes corresponding to a smallest one of the offset degrees as the optimal-matching two-wheel carrier object box; and
merge the i-th one of the rider object boxes and the optimal-matching two-wheel carrier object box into the merged object box, add the merged object box to the first memory, and delete the optimal-matching two-wheel carrier object box in the first memory.

4. The image processing system as claimed in claim 1, wherein the merging unit is further configured to:
obtain the geometric parameter groups of the i-th one of the rider object boxes and the two-wheel carrier object boxes in the first memory, wherein each geometric parameter group comprises geometric parameters W1, W2, W3, H1 and H2, (x1_r, y1_r) is a coordinate of an upper left corner point of the i-th one of the rider object boxes, (x2_r, y2_r) is a coordinate of a lower right corner point of the i-th one of the rider object boxes, (x1_t, y1_t) is a coordinate of an upper left corner point of the corresponding two-wheel carrier object box, and (x2_t, y2_t) is a coordinate of a lower right corner point of the corresponding two-wheel carrier object box by using formulas (1a) to (1e);
$$W 1 = x1\_r - x1\_t ; \qquad ( 1 a )$$
$$W 2 = x2\_r - x2\_t ; \qquad ( 1 b )$$
$$W 3 = x1\_r - x2\_t ; \qquad ( 1 c )$$
$$H 1 = y2\_r - y1\_t ; \qquad ( 1 d )$$
$$H 2 = y2\_r - y2\_t . \qquad ( 1 e )$$

5. The image processing system as claimed in claim 4, wherein the merging unit is further configured to:
when W1≥0, W2≥0, H1≥0 and H2<0 are satisfied, use the two-wheel carrier object box that satisfies formulas (211) and (214) as at least one two-wheel carrier object box that matches the i-th one of the rider object boxes;
$$Abs ( \frac{W 1}{W 3} ) \leq Th1\_W ; \qquad ( 211 )$$
$$\frac{{A}_{r}}{{A}_{t}} \leq Th\_area ; \qquad ( 214 )$$
wherein Th1_W and Th_area are threshold values.

6. The image processing system as claimed in claim 5, wherein formulas (211) is replaced by formula (215);
$$Abs ( \frac{W 1}{( W 1 + W 3 )} ) \leq Th3\_W ; \qquad ( 215 )$$
wherein Th3_W is a threshold value.

7. The image processing system as claimed in claim 4, wherein the merging unit is further configured to:
when W1<0, W2<0, H1≥0 and H2<0 are satisfied, use the two-wheel carrier object box that satisfies formulas (212) and (214) as at least one two-wheel carrier object box that matches the i-th one of the rider object boxes;
$$Abs ( \frac{W 2}{W 3} ) \leq Th2\_W ; \qquad ( 212 )$$
$$\frac{{A}_{r}}{{A}_{t}} \leq Th\_area ; \qquad ( 214 )$$
wherein Th2_W and Th_area are threshold values.

8. The image processing system as claimed in claim 7, wherein formula (212) is replaced by formula (216);
$$Abs ( \frac{W 2}{( W 2 + W 3 )} ) \leq Th4\_W ; \qquad ( 216 )$$
wherein Th4_W is a threshold value.

9. The image processing system as claimed in claim 4, wherein the merging unit is further configured to:
when W1≥0, W2<0, H1≥0 and H2<0 are satisfied, use the two-wheel carrier object box that satisfies formula (214) as at least one two-wheel carrier object box that matches the i-th one of the rider object boxes;
$$\frac{{A}_{r}}{{A}_{t}} \leq Th\_area ; \qquad ( 214 )$$
wherein Th_area is a threshold value.

10. The image processing system as claimed in claim 4, wherein the merging unit is further configured to:
when W1<0, W2≥0, H1≥0 and H2<0 are satisfied, use the two-wheel carrier object box that satisfies formula (214) as at least one two-wheel carrier object box that matches the i-th one of the rider object boxes;
$$\frac{{A}_{r}}{{A}_{t}} \leq Th\_area ; \qquad ( 214 )$$
wherein Th_area is a threshold value.

11. The image processing system as claimed in claim 4, wherein the merging unit is further configured to:
when W1≥0, W2≥0, H1<0 and H2<0 are satisfied, use the two-wheel carrier object box that satisfies formulas (211), (213) and (214) as at least one two-wheel carrier object box that matches the i-th one of the rider object boxes;
$$Abs ( \frac{W 1}{W 3} ) \leq Th1\_W ; \qquad ( 211 )$$
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th1_W, Th1_H and Th_area are threshold values.

12. The image processing system as claimed in claim 11, wherein formula (211) is replaced by formula (215), and formula (213) is replaced by formula (217);
$$Abs ( \frac{W 1}{( W 1 + W 3 )} ) \leq Th3\_W ; \qquad ( 215 )$$
$$Abs ( \frac{H 1}{H 2 - H 1} ) \leq Th2\_H ; \qquad ( 217 )$$
wherein Th3_W and Th2_H are threshold values.

13. The image processing system as claimed in claim 4, wherein the merging unit is further configured to:
when W1<0, W2<0, H1<0 and H2<0 are satisfied, use the two-wheel carrier object box that satisfies formulas (211), (213) and (214) as at least one two-wheel carrier object box that matches the i-th one of the rider object boxes;
$$Abs ( \frac{W 2}{W 3} ) \leq Th2\_W ; \qquad ( 212 )$$
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th2_W, Th1_H and Th_area are threshold values.

14. The image processing system as claimed in claim 13, wherein formula (212) is replaced by formula (216), and formula (213) is replaced by formula (217);
$$Abs ( \frac{W 2}{( W 2 + W 3 )} ) \leq Th4\_W ; \qquad ( 216 )$$
$$Abs ( \frac{H 1}{H 2 - H 1} ) \leq Th2\_H ; \qquad ( 217 )$$
wherein Th4_W and Th2_H are threshold values.

15. The image processing system as claimed in claim 4, wherein the merging unit is further configured to:
when W1≥0, W2<0, H1<0 and H2<0 are satisfied, use the two-wheel carrier object box that satisfies formulas (213) and (214) as at least one two-wheel carrier object box that matches the i-th one of the rider object boxes;
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th1_H and Th_area are threshold values.

16. The image processing system as claimed in claim 15, wherein formula (213) is replaced by formula (217);
$$Abs ( \frac{H 1}{H 2 - H 1} ) \leq Th2\_H ; \qquad ( 217 )$$
wherein Th2_H is a threshold value.

17. The image processing system as claimed in claim 4, wherein the merging unit is further configured to:
when W1<0, W2≥0, H1<0 and H2<0 are satisfied, use the two-wheel carrier object box that satisfies formulas (213) and (214) as at least one two-wheel carrier object box that matches the i-th one of the rider object boxes;
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th1_H and Th_area are threshold values.

18. The image processing system as claimed in claim 17, wherein formula (213) is replaced by formula (217);
$$Abs ( \frac{H 1}{H 2 - H 1} ) \leq Th2\_H ; \qquad ( 217 )$$
wherein Th2_H is a threshold value.

19. An image processing method for merging a rider object box and a two-wheel carrier object box, comprising:
storing a plurality of the rider object boxes and a plurality of the two-wheel carrier object boxes by a first memory;
reading the rider object boxes in the first memory by an area sorting unit;
calculating a rider object box area of each of the rider object boxes by the area sorting unit;
arranging the rider object boxes in a descending order of the rider object box areas and storing the arranged rider object boxes in the second memory by the area sorting unit;
deleting all rider object boxes in the first memory by a data update unit;
for each of the rider object boxes in the second memory, obtaining an optimal-matching two-wheel carrier object box from the two-wheel carrier object boxes in the first memory by a merging unit; and
merging each of the rider object boxes and the corresponding optimal-matching two-wheel carrier object box to create a merged object box by the merging unit, wherein an area of the merged object box covers an area of the corresponding rider object box and an area of its optimal-matching two-wheel carrier object box.

20. The image processing method as claimed in claim 19, further comprising:
calculate a geometric parameter group of each of the two-wheel carrier object boxes in the first memory and an i-th one of the rider object boxes in the second memory by the merging unit, wherein i is a positive integer ranging between 1 and N, N is total number of all rider object boxes in the second memory, and a value of N is a positive integer equal to or greater than 1;
determining a relative position type of each of the geometric parameter groups by the merging unit;
determining whether there is the two-wheel carrier object box that matches the i-th one of the rider object boxes from the first memory according to the relative position type of each geometric parameter group by the merging unit;
when there is no the two-wheel carrier object box that matches the i-th one of the rider object boxes, not adding the merging object box by the merging unit;
when the number of the two-wheel carrier object boxes that matches the i-th one of the rider object boxes is 1, merging the i-th one of the rider object boxes and the two-wheel carrier object box that matches the i-th one of the rider object boxes into the merged object box by the merging unit, adding the merged object box to the first memory by the merging unit, and deleting the two-wheel carrier object box that matches the i-th one of the rider object boxes into the merged object box in the first memory by the merging unit; and
when the number of the two-wheel carrier object boxes that matches the i-th one of the rider object boxes is plural, from the matching two-wheel carrier object boxes, comparing a center distance of each two-wheel carrier object box that matches the i-th one of the rider object boxes and the i-th one of the rider object boxes by the merging unit, using the two-wheel carrier object box that matches the i-th one of the rider object boxes corresponding to a smallest one of the center distances as the optimal-matching two-wheel carrier object box by the merging unit, merging the i-th one of the rider object boxes and the optimal-matching two-wheel carrier object box into the merged object box by the merging unit, and deleting the optimal-matching two-wheel carrier object box in the first memory by the merging unit.

21. The image processing method as claimed in claim 19 further comprising:
when the number of the two-wheel carrier object boxes that matches the i-th one of the rider object boxes is plural, from the two-wheel carrier object boxes that matches the i-th one of the rider object boxes, comparing an offset degree of each two-wheel carrier object box that matches the i-th one of the rider object boxes and the i-th one of the rider object boxes along an axis by the merging unit;
using the two-wheel carrier object boxes that matches the i-th one of the rider object boxes corresponding to a smallest one of the offset degrees as the optimal-matching two-wheel carrier object box by the merging unit; and
merging the i-th one of the rider object boxes and the optimal-matching two-wheel carrier object box into the merged object box by the merging unit, adding the merged object box to the first memory by the merging unit, and deleting the optimal-matching two-wheel carrier object box in the first memory by the merging unit.

22. The image processing method as claimed in claim 19 further comprising:
obtaining the geometric parameter groups of the i-th one of the rider object boxes and the two-wheel carrier object boxes in the first memory by the merging unit, wherein each geometric parameter group comprises geometric parameters W1, W2, W3, H1 and H2, (x1_r, y1_r) is a coordinate of an upper left corner point of the i-th one of the rider object boxes, (x2_r, y2_r) is a coordinate of a lower right corner point of the i-th one of the rider object boxes, (x1_t, y1_t) is a coordinate of an upper left corner point of the corresponding two-wheel carrier object box, and (x2_t, y2_t) is a coordinate of a lower right corner point of the corresponding two-wheel carrier object box by using formulas (1a) to (1e);
$$W 1 = x1\_r - x 1 \_t ; \qquad ( 1 a )$$
$$W 2 = x2\_r - x2\_t ; \qquad ( 1 b )$$
$$W 3 = x1\_r - x2\_t ; \qquad ( 1 c )$$
$$H 1 = y2\_r - y1\_t ; \qquad ( 1 d )$$
$$H 2 = y2\_r - y2\_t . \qquad ( 1 e )$$

23. The image processing method as claimed in claim 22, further comprising:
when W1≥0, W2≥, H1≥0 and H2<0 are satisfied, using the two-wheel carrier object box that satisfies formulas (211) and (214) as at least one two-wheel carrier object box that matches the i-th one of the rider object boxes by the merging unit;
$$Abs ( \frac{W 1}{W 3} ) \leq Th1\_W ; \qquad ( 211 )$$
$$\frac{{A}_{r}}{{A}_{t}} \leq Th\_area ; \qquad ( 214 )$$
wherein Th1_W and Th_area are threshold values.

24. The image processing method as claimed in claim 23, wherein formula (211) is replaced by formula (215);
$$Abs ( \frac{W 1}{( W 1 + W 3 )} ) \leq Th3\_W ; \qquad ( 215 )$$
wherein Th3_W is a threshold value.

25. The image processing method as claimed in claim 22, further comprising:
when W1<0, W2<0 H1≥0 and H2<0 are satisfied, using the two-wheel carrier object box that satisfies formulas (212) and (214) as at least one two-wheel carrier object box that matches the i-th one of the rider object boxes by the merging unit;
$$Abs ( \frac{W 2}{W 3} ) \leq Th2\_W ; \qquad ( 212 )$$
$$\frac{{A}_{r}}{{A}_{t}} \leq Th\_area ; \qquad ( 214 )$$
wherein Th2_W and Th_area are threshold values.

26. The image processing method as claimed in claim 25, wherein formula (212) is replaced by formula (216);
$$Abs ( \frac{W 2}{( W 2 + W 3 )} ) \leq Th4\_W ; \qquad ( 216 )$$
wherein Th4_W is a threshold value.

27. The image processing method as claimed in claim 22, further comprising:
when W1≥0, W2<0 H1≥0 and H2<0 are satisfied, using the two-wheel carrier object box that satisfies formula (214) as at least one two-wheel carrier object box that matches the i-th one of the rider object boxes by the merging unit;
$$\frac{{A}_{r}}{{A}_{t}} \leq Th\_area ; \qquad ( 214 )$$
wherein Th_area is a threshold value.

28. The image processing method as claimed in claim 22 further comprising:
when W1<0 W2≥, H1≥0 and H2<0 are satisfied, using the two-wheel carrier object box that satisfies formula (214) as at least one two-wheel carrier object box that matches the i-th one of the rider object boxes by the merging unit;
$$\frac{{A}_{r}}{{A}_{t}} \leq Th\_area ; \qquad ( 214 )$$
wherein Th_area is a threshold value.

29. The image processing method as claimed in claim 22, further comprising:
when W1≥0, W2≥0, H1<0 and H2<0 are satisfied, using the two-wheel carrier object box that satisfies formulas (211), (213) and (214) as at least one two-wheel carrier object box that matches the i-th one of the rider object boxes by the merging unit;
$$Abs ( \frac{W 1}{W 3} ) \leq Th1\_W ; \qquad ( 211 )$$
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th1_W, Th1_H and Th_area are threshold values.

30. The image processing method as claimed in claim 29, wherein formula (211) is replaced by formula (215), and formula (213) is replaced by formula (217);
$$Abs ( \frac{W 1}{( W 1 + W 3 )} ) \leq Th3\_W ; \qquad ( 215 )$$
$$Abs ( \frac{H 1}{H 2 - H 1} ) \leq Th2\_H ; \qquad ( 217 )$$
wherein Th3_W and Th2_H are threshold values.

31. The image processing method as claimed in claim 22, further comprising:
when W1<0, W2<0, H1<0 and H2<0 are satisfied, using the two-wheel carrier object box that satisfies formulas (211), (213) and (214) as at least one two-wheel carrier object box that matches the i-th one of the rider object boxes by the merging unit;
$$Abs ( \frac{W 2}{W 3} ) \leq Th2\_W ; \qquad ( 212 )$$
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th2_W, Th1_H and Th_area are threshold values.

32. The image processing method as claimed in claim 31, wherein formula (212) is replaced by formula (216), and formula (213) is replaced by formula (217);
$$Abs ( \frac{W 2}{( W 2 + W 3 )} ) \leq Th4\_W ; \qquad ( 216 )$$
$$Abs ( \frac{H 1}{H 2 - H 1} ) \leq Th2\_H ; \qquad ( 217 )$$
wherein Th4_W and Th2_H are threshold values.

33. The image processing method as claimed in claim 22, further comprising:
when W1≥0, W2<0, H1<0 and H2<0 are satisfied, use the two-wheel carrier object box that satisfies formulas (213) and (214) as at least one two-wheel carrier object box that matches the i-th one of the rider object boxes by the merging unit;
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th1_H and Th_area are threshold values.

34. The image processing method as claimed in claim 33, wherein formula (213) is replaced by formula (217);
$$Abs ( \frac{H 1}{H 2 - H 1} ) \leq Th2\_H ; \qquad ( 217 )$$
wherein Th2_H is a threshold value.

35. The image processing method as claimed in claim 22, further comprising:
when W1<0 W2≥0, H1<0 and H2<0 are satisfied, using the two-wheel carrier object box that satisfies formulas (213) and (214) as at least one two-wheel carrier object box that matches the i-th one of the rider object boxes by the merging unit;
$$Abs ( \frac{H 1}{H 2} ) \leq Th1\_H ; \qquad ( 213 )$$
$$\frac{{A}_{r}}{{A}_{t}} \leq Th\_area ; \qquad ( 214 )$$
wherein Th1_H and Th_area are threshold values.

36. The image processing method as claimed in claim 35, wherein formula (213) is replaced by formula (217);
$$Abs ( \frac{H 1}{H 2 - H 1} ) \leq Th2\_H ; \qquad ( 217 )$$
wherein Th2_H is a threshold value.
